(19) United States
(12) Patent Application Publication
(10) Pub. No.: US 2004/0114666 A1
(43) Pub. Date: Jun. 17, 2004

(54) Temperature sensing structure, method of making the structure, gas turbine engine and method of controlling temperature

(76) Inventors: Canan Uslu Hardwicke, Niskayuna, NY (US); Melvin Robert Jackson, Niskayuna, NY (US); Michael Francis Xavier Gigliotti JR., Glenville, NY (US); Stephen F. Rutkowski, Duanesburg, NY (US); Robert John Zabala, Guilderland, NY (US)

Correspondence Address: Philip D. Freedman, Philip D. Freedman PC, 6000 Wescott Hills Way, Alexandria, VA, 22314-4747, US

(21) Appl. No.: 10/320,677

(22) Filed: Dec. 17, 2002

(51) Int. Cl. G01K 11/00

(52) U.S. Cl. 374/179

(57) ABSTRACT

A gas turbine engine comprises (A) a turbine including a nozzle and shroud assembly supported within the engine; the nozzle and shroud assembly including an inner annular ring member, an outer annular ring structure and a plurality of airfoils being positioned between the inner and outer ring structure, wherein at least one of the airfoils of the plurality comprises; (i) a substrate comprising a first electrically conducting material; and (ii) a wire of dissimilar electrically conducting material extending a measured distance in intimate contact with the substrate at a reference point and electrically insulated to a measuring point. A method of controlling the temperature of a turbine engine, comprises providing at least one sensing structure, comprising a substrate comprising a first electrically conducting material; a wire of dissimilar electrically conducting material extending a measured distance in intimate contact with the substrate at a reference point and electrically insulated from the substrate to a measuring point; and a measuring device connected to the substrate and wire at the measuring point; detecting a voltage that is relative to the temperature of the substrate at the reference point with the measuring device; and controlling the temperature of the turbine engine according to the voltage detected by the measuring device.

### BACKGROUND OF THE INVENTION

The invention relates to a temperature sensing structure, method of making the structure, a gas turbine engine that includes the structure and a method of controlling temperature of a gas turbine engine. Particularly, the invention relates to a “smart material” part, more particularly a turbine engine part that senses its own temperature.

Engine combustion temperature can be controlled by sensing an operational parameter, such as temperature and regulating operation accordingly. For example, the operation of an engine can be adjusted according to a local engine part temperature that is sensed by a sensing apparatus such as a thermocouple. Temperature control of an engine is important. For example, unnecessarily high turbine engine combustion temperature can compromise fuel efficiency and increase emission pollution. For example, in a gas turbine designed to emit nine nitrogen oxide (NOₓ) particles per million (ppm), an increase from 2730° F. (1499° C.) to 2740° F. (1504° C.) reduces turbine efficiency by about two percent and increases NOₓ emissions by about two ppm. On an annual basis, this can amount to millions of dollars of lost revenue and to several tons increase in NOₓ emission.

However, the internal geometry of some engines requires emplacement of a sensor at a location deep within a complex structure. Maintenance and replacement of the sensor may require disassembly and reassembly of the part. Or, the geometry of the engine or local engine part may prevent local placement of a sensor altogether.

Thus, there is a need for an improved temperature sensing structure capable of locally detecting temperature in complex engine locations or locations deep within an engine structure.

### BRIEF DESCRIPTION OF THE INVENTION

The invention provides a temperature sensing structure and a method of making a temperature sensing structure capable of locally detecting temperature in complex engine locations or locations deep within an engine structure. The sensing structure comprises a substrate comprising a first electrically conducting material; a dissimilar electrically conducting material extending a measured distance in intimate contact with the substrate from a reference point to a measuring point; and a measuring device connected to the substrate and dissimilar material at the measuring point to detect a voltage that is relative to a temperature of the substrate.

In an embodiment, the invention relates to a gas turbine engine that comprises (A) a turbine including a nozzle and shroud assembly supported within the engine; the nozzle and shroud assembly including an inner annular ring member, an outer annular ring structure and a plurality of airfoils being positioned between the outer and outer ring structure, wherein at least one of the airfoils of the plurality comprises (i) a substrate comprising a first electrically conducting material; and (ii) a wire of dissimilar electrically conducting material extending a measured distance in intimate contact with the substrate at a reference point, and electrically insulated from the substrate to a measuring point. Further, the gas turbine engine comprises (B) a combustor disposed between the compressor and turbine for receiving compressed air from the compressor and fuel through a valve for producing combustion gas discharged to the turbine; (C) a measuring device connected to the substrate and wire at the measuring point to detect a voltage that is relative to the temperature of the substrate at the reference point where substrate and wire are in intimate contact; and (D) a controller that regulates fuel flow to the combustor in response to the voltage detected by the measuring device.

In another embodiment, the invention relates to a method of controlling the temperature of a turbine engine, comprising providing at least one sensing structure, comprising a substrate comprising a first electrically conducting material; a wire of dissimilar electrically conducting material extending a measured distance in intimate contact with the substrate at a reference point and electrically insulated from the substrate to a measuring point; and a measuring device connected to the substrate and wire at the measuring point; detecting a voltage that is relative to a temperature of the substrate at the reference point where substrate and wire are in intimate contact; and controlling the temperature of the turbine engine according to the voltage detected by the measuring device.

### BRIEF DESCRIPTION OF THE DRAWING

FIG. 1A to FIG. 1D schematically illustrate a method of making a sensing structure with FIG. 1D representing the completed structure;

FIG. 2 is a schematic elevation view of a controlled gas turbine engine;

FIG. 3 and FIG. 4 are schematic details in perspective of rotor airfoil blades of the FIG. 2 engine;

FIG. 5 is a schematic plan view of an experimental set up according to EXAMPLE 1; and

FIG. 6 is a graph of experimental results.

### DETAILED DESCRIPTION OF THE INVENTION

The invention can transform a part into a “smart material” sensing structure to be used as an element of an overall system to control temperature. The term “smart material” refers to a material able to sense a system property to provide a signal that actuates a useful response. A smart material can sense a change in an environment and can use a feedback system to generate the useful response. The invention converts a part to a smart material for sensing temperature. The smart material part can be used as part of a “real time” active monitoring system. “Real time” monitoring is monitoring of an event during the actual time the event takes place.

Features of the invention will become apparent from the drawings and following detailed discussion, which by way of example without limitation describe preferred embodiments of the invention.

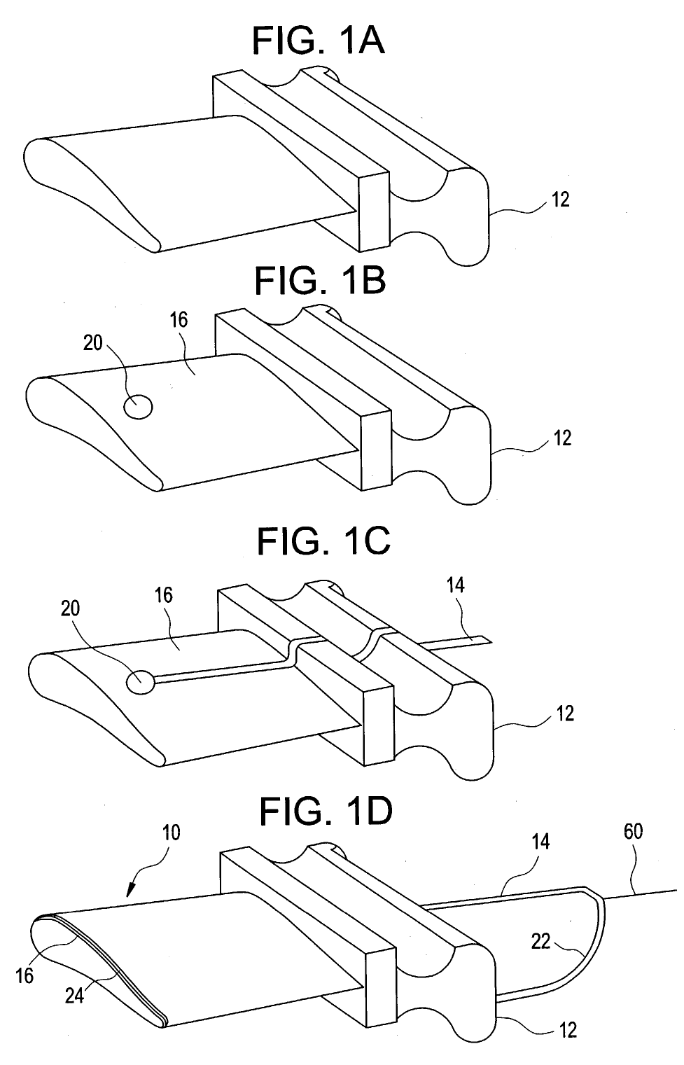

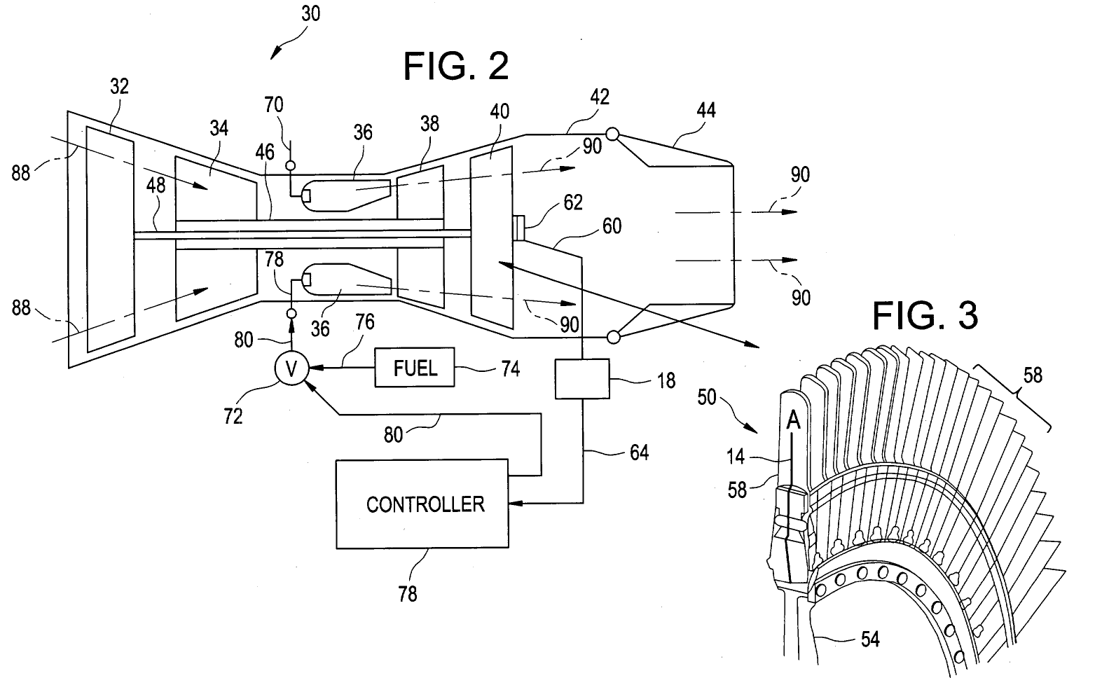

FIG. 1A to FIG. 1D schematically illustrate a method of making a preferred embodiment sensing structure with FIG. 1D representing the completed structure. First referring to FIG. 1C and FIG. 1D, sensing structure 10 comprises a substrate of a first electrically conducting material and an applied dissimilar electrically conducting material. Exemplary combinations of first electrically conducting material and applied dissimilar electrically conducting material include Rh—Pt—Pd, Pt—Rh, Pt—Pd, Rh—Pd, Zr—Pt—Rh, Au—Pt—Rh, Ag—Pt—Rh, Zr—Pt—Pd, Au—Pt—Pd, Au—Cr—Ru—Ni, Au—Pt, Au—Pd, W—Re, Ni—Cr, Ni—Mn—Al, Mn—Ni, Ni—Cr—Si—Mg, Ni—Si—Mg, Ni—Co, and Ni—Mo, or electrically conducting ceramics. In the embodiment shown in the figures, the substrate is an airfoil 12 that can be constructed from a nickel-base, iron-base, cobalt-base, chrome-base, niobium-base, molybdenum-base, copper-base, titanium-base or aluminum-base alloy, an electrically-conducting ceramic composition, or a composite reinforced with an electrically-conducting phase, such as carbon or a carbide and the dissimilar material is wire 14, such as Rh—Pt—Pd, Pt—Rh, Pt—Pd, Rh—Pd, Zr—Pt—Rh, Au—Pt—Rh, Ag—Pt—Rh, Zr—Pt—Pd, Au—Pt—Pd, Au—Cr—Ru—Ni, Au—Pt, Au—Pd, W—Re, Ni—Cr, Ni—Mn—Al, Mn—Ni, Ni—Cr—Si—Mg, Ni—Si—Mg, Ni—Co, and Ni—Mo, or electrically conducting ceramics. FIG. 1D also shows coating 16 covering the airfoil 12. Wire 14 and a thermocouple leg 22 connect from the airfoil 12 to a measuring device 18 shown in FIG. 2.

In accordance with a preferred embodiment of the method of the invention, airfoil 12 is provided as shown in FIG. 1A. The airfoil 12 is covered with an electrically insulating coating 16 as shown in FIG. 1B. A portion of coating 16 is removed to define a region 20 of exposed underlying airfoil 12. Wire 14 is connected in intimate contact to the airfoil 12 at region 20. The wire 14 extends from reference point region 20 to a measuring point at a measuring device 18 such as a measurement transducer. The wire 14 and airfoil coating 16 can be covered with a top surface 24, for example a thermal barrier coating selected from oxides, nitrides, carbides, borides or their mixtures that melt above the use temperature of the part. Suitable coatings can include Al₂O₃, ZrO₂, Y₂O₃, rare-earth oxides and mixtures of rare-earth oxides. Leg 22 electrically connects airfoil 12 to the same measuring point at measuring device 18. Measuring device 18 detects a voltage at the measuring point that is relative to the temperature of the airfoil at the measuring point.

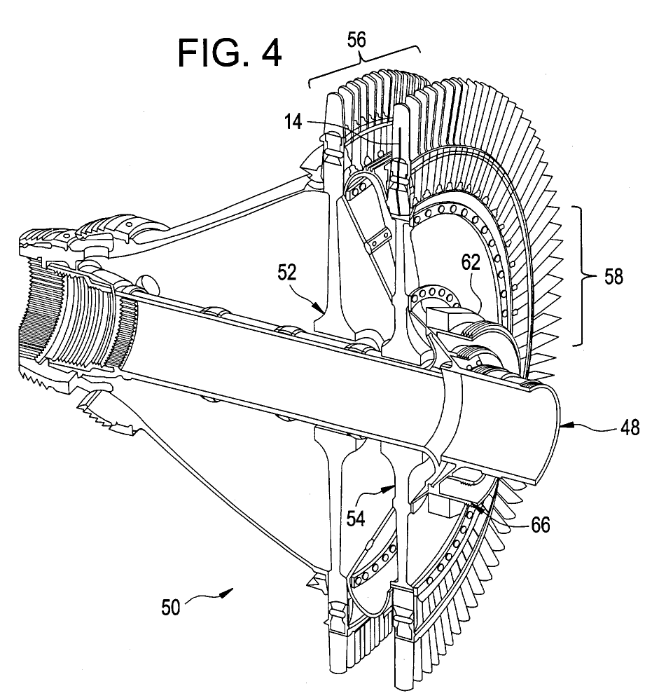

FIG. 2 shows an exemplary gas turbine engine 30 configured to include in serial flow communication, low pressure compressor 32; high pressure compressor 34; annular combustor 36; high pressure turbine 38, which may be a single stage; and low pressure turbine 40, which may also be a single stage; augmenter 42 and a cooperating variable area exhaust nozzle 44. High pressure turbine 38 includes rotor 50 with airfoils 56, 58. An exemplary detail of an airfoil is shown in the perspective views of FIG. 3 and FIG. 4. The high pressure turbine 38 is fixedly joined to the high pressure compressor 34 by core shaft 46. The low pressure turbine 40 is fixedly joined to the low pressure compressor 32 by shaft 48.

FIG. 3 and FIG. 4 are schematic perspective representations of details of the rotor 50 of the FIG. 2 engine 30. Rotor 50 includes two disks 52, 54 respectively with stage 1 and 2 circumferentially spaced apart blades comprising airfoils 56, 58. The disks, 52, 54 are attached to shaft 48, which is also shown in FIG. 2. Wire 14 and leg 22 (shown in FIG. 4D) converge to a single lead or pair of leads, 60 through slip ring 62. Lead or lead-pair, 60 connect to measuring device 18, shown in FIG. 2. Measuring device 18 generates a thermocouple signal 64.

Referring to FIG. 2, a plurality of fuel injectors 70 are mounted around the upstream inlet end of the combustor 36, disposed in flow communication with a fuel control valve 72. The valve 72 is suitably joined to a fuel tank 74, which contains a fuel that is pressurized and provided 76 to the valve 72 for metered flow to the injectors 70. The engine 30 also includes a digitally programmable controller 78, which may be a computer or the like. The controller 78 is electrically joined to the fuel valve 72 for metering fuel flow 60+− into the combustor 36.

In normal operation, air 88 enters the low pressure compressor 32 and is pressurized through the compressor 34, mixed with fuel 80 in the combustor 36 and suitably ignited for generating hot combustion gas 90. The hot combustion gas 90 is discharged from the combustor 36 to enter the high pressure turbine 38. High pressure turbine 38 extracts energy from the gas 90 for powering the compressor 34. Combustion gas 90 in turn flows downstream through low pressure turbine 40, which extracts additional energy from gas 90 for powering the fan of compressor 32.

In operation, airfoil 56 of disk 54 acts as a thermocouple sensing structure 10 according to the Seebeck principle. The wire 14 and airfoil 12 comprise dissimilar materials that are eventually joined at the wire 14 and leg 22 joinder 26 to lead-pair 60. When airfoil 12 is heated at region 20, a voltage is created between wire 14 and airfoil 12 at the location of lead-pair 60. The voltage is proportional to a temperature difference between position 20 and position 60 and to the composition of the dissimilar materials of the airfoil 12 and wire 14. The voltage is measured by measuring device 18. The device 18 voltage information is input into controller 78. If the controller 78 determines that temperature should be modified then the controller 78 activates the value 72, either increasing or lessening fuel flow to combustor 36. In response, combustor 36 either increases or decreases firing to control the temperature of combustion gas 90 to correspondingly adjust the temperature of airfoil region 20.

The drawings illustrate the invention with respect to a sensing structure that comprises airfoil 12 and wire 14. However, the sensing structure can comprise any modified part that is exposed to a thermal environment. For example, the sensing structure could be a part of a single or multiple spool engine, turbojet, turbofan, afterbuming or non-afterburning engine, axial or centrifugal compressor engine or axi-centrifugal compressor engine.

The dissimilar electrically conducting material of the sensing structure needs to form a continuous electrical connection from the reference point at which it contacts the substrate. This material and structure need not be an attached wire, but could be a continuous line formed by deposition of vapor or by application and drying of a liquid or similar techniques to directly write a conducting line.

The following EXAMPLE is illustrative and should not be construed as a limitation on the scope of the claims.

### EXAMPLE

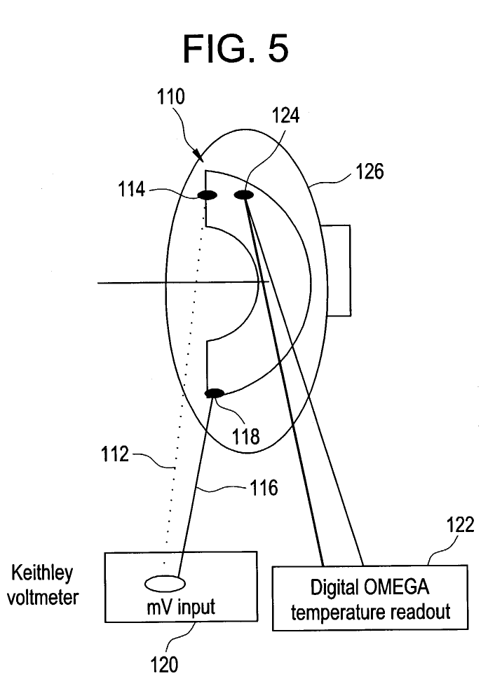

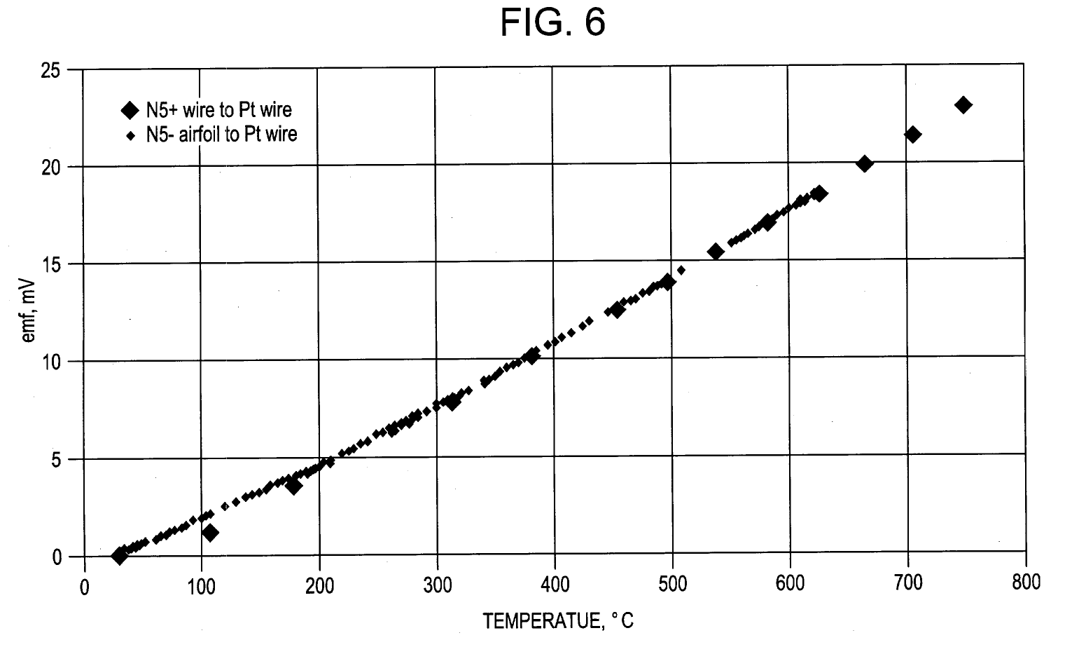

Combinations of commercially available conductive engineering materials were evaluated to assess electrical performance and reproducibility. FIG. 5 of the drawings is a schematic plan view of the experimental set up of this EXAMPLE and FIG. 6 is a graph of results.

An airfoil sensing structure was simulated with a nickel based superalloy blade made of René N5 alloy and a platinum wire spot-welded to the blade. FIG. 6 shows results of a comparison of a René N5 wire and a Pt wire sensor compared to the airfoil sensing structure in the arrangement shown in FIG. 5. The correspondence shown in FIG. 6 illustrates sensing equivalence between a conventional sensor and a sensing structure according to the invention

While preferred embodiments of the invention have been described, the present invention is capable of variation and modification and therefore should not be limited to the precise details of the Examples. The invention includes changes and alterations that fall within the purview of the following claims.

What is claimed is:

1. A sensing structure, comprising:
a substrate comprising a first electrically conducting material;
a dissimilar electrically conducting material extending a measured distance in intimate contact with the substrate at a reference point and electrically insulated from the substrate to a measuring point; and
a measuring device connected to the substrate and dissimilar material at the measuring point to detect a voltage that is relative to the temperature of the substrate at the reference point.

2. The sensing structure of claim 1, wherein the substrate comprises a combustion engine component.

3. The sensing structure of claim 1, wherein the structure is a turbine engine part.

4. The sensing structure of claim 1, wherein the dissimilar electrically conducting material comprises a wire embedded within the substrate.

5. The sensing structure of claim 1, wherein the dissimilar electrically conducting material comprises a wire embedded between the substrate and a coating on the substrate.

6. The sensing structure of claim 1, wherein the dissimilar electrically conducting material comprises Rh—Pt—Pd, Pt—Rh, Pt—Pd, Rh—Pd, Zr—Pt—Rh, Au—Pt—Rh, Ag—Pt—Rh, Zr—Pt—Pd, Au—Pt—Pd, Au—Cr—Ru—Ni, Au—Pt, Au—Pd, W—Re, Ni—Cr, Ni—Mn—Al, Mn—Ni, Ni—Cr—Si—Mg, Ni—Si—Mg, Ni—Co, and Ni—Mo or an electrically conducting ceramic.

7. The sensing structure of claim 1, wherein the substrate comprises an airfoil.

8. The sensing structure of claim 1, wherein the substrate is an airfoil comprising a nickel-base, iron-base, cobalt-base, chrome-base, niobium-base, molybdenum-base, copper-base, titanium-base or aluminum-base alloy, an electrically-conducting ceramic composition or a composite reinforced with an electrically-conducting phase.

9. The sensing structure of claim 1, wherein the substrate is an airfoil comprising a composite reinforced with an electrically-conducting carbon phase or carbide phase.

10. The sensing structure of claim 1, wherein the dissimilar electrically conducting material comprises a continuous line formed by deposition of vapor or liquid.

11. The sensing structure of claim 10, wherein the dissimilar electrically conducting material is a continuous line formed by deposition of vapor or liquid comprising Rh—Pt—Pd, Pt—Rh, Pt—Pd, Rh—Pd, Zr—Pt—Rh, Au—Pt—Rh, Ag—Pt—Rh, Zr—Pt—Pd, Au—Pt—Pd, Au—Cr—Ru—Ni, Au—Pt, Au—Pd, W—Re, Ni—Cr, Ni—Mn—Al, Mn—Ni, Ni—Cr—Si—Mg, Ni—Si—Mg, Ni—Co, Ni—Mo or an electrically conducting ceramic.

12. The sensing structure of claim 1, additionally comprising a coating applied onto the substrate and the dissimilar material.

13. The sensing structure of claim 1, additionally comprising a coating applied onto the substrate and the dissimilar material, wherein the coating comprises Al₂O₃, ZrO₂, Y₂O₃, rare-earth oxides or mixtures of rare-earth oxides.

14. A method of making a sensing structure, comprising:
providing a substrate comprising a first electrically conducting material;
applying a dissimilar electrically conducting material onto the substrate to extend a measured distance in intimate contact with the substrate at a reference point and electrically insulated from the substrate to a measuring point; and
connecting a measuring device to the substrate and dissimilar electrically conducting material at the measuring point to detect a voltage that is relative to the temperature of the substrate at the reference point.

15. The method of claim 14, comprising applying an electrically-insulating coating onto a substrate and removing a portion of the coating at a region at which temperature is to be sensed to provide the substrate comprising the first electrically conducting material.

16. The method of claim 14, comprising applying an electrically-insulating coating onto a substrate and removing a portion of the coating at a region at which temperature is to be sensed to provide an exposed substrate comprising the first electrically conducting material; and
applying the dissimilar electrically conducting material onto the exposed substrate to extend a measured distance in intimate contact with the substrate at a reference point and electrically insulated from the substrate to a measuring point.

17. The method of claim 14, comprising applying an electrically insulating coating onto a substrate and removing a portion of the coating at a region at which temperature is to be sensed to provide an exposed substrate comprising the first electrically conducting material;
applying the dissimilar electrically conducting material onto the exposed substrate to extend a measured distance in intimate contact with the substrate at a reference point and electrically insulated from the substrate to a measuring point; and
applying a protective coating onto the dissimilar electrically conducting material.

18. The method of claim 14, comprising applying an electrically insulating coating onto a substrate and removing a portion of the coating at a region at which temperature is to be sensed to provide an exposed substrate comprising the first electrically conducting material;
applying the dissimilar electrically conducting material onto the exposed substrate to extend a measured distance in intimate contact with the substrate at a reference point and electrically insulated from the substrate to a measuring point; and
connecting the substrate by a wire of the same first electrically conducting material to the measuring device and extending the dissimilar electrically conducting material in the form of a wire connected to the measuring device.

19. A gas turbine engine comprising:
(A) a turbine including a nozzle and shroud assembly supported within the engine; the nozzle and shroud assembly including an inner annular ring member, an outer annular ring structure and a plurality of airfoils being positioned between the outer ring structure and plurality of airfoils, wherein at least one of the airfoils of the plurality comprises:
(i) a substrate comprising a first electrically conducting material; and
(ii) a wire of dissimilar electrically conducting material extending a measured distance in intimate contact with the substrate at a reference point and electrically insulated from the substrate to a measuring point;
(B) a combustor disposed between the compressor and turbine for receiving compressed air from the compressor and fuel through a valve for producing combustion gas discharged to the turbine;
(C) a measuring device connected to the substrate and wire at the measuring point to detect a voltage that is relative to a temperature of the substrate; and
(D) a controller that regulates fuel flow to the combustor in response to the voltage detected by the measuring device.

21. A method of controlling the temperature of a turbine engine, comprising:
providing at least one sensing structure, comprising a substrate comprising a first electrically conducting material; a wire of dissimilar electrically conducting material extending a measured distance in intimate contact with the substrate at a reference point and electrically insulated from the substrate to a measuring point; and a measuring device connected to the substrate and wire at the measuring point;
detecting a voltage that is relative to the temperature of the substrate at the reference point with the measuring device; and
controlling the temperature of the turbine engine according to the voltage detected by the measuring device.
